(19) United States
(12) Patent Application Publication
(10) Pub. No.: US 2018/0074006 A1
(43) Pub. Date: Mar. 15, 2018

(54) ANALYSIS DEVICE AND ANALYSIS METHOD

(71) Applicant: Hitachi, Ltd., Tokyo (JP)

(72) Inventors: Yusuke GOTO, Tokyo (JP); Takahide YOKOI, Tokyo (JP)

(21) Appl. No.: 15/553,177

(22) PCT Filed: May 11, 2015
(86) PCT No.: PCT/JP2015/063514

§ 371 Date: Aug. 24, 2017

(51) Int. Cl. G01N 27/30; G01N 27/40

(52) U.S. Cl. CPC G01N 27/30; G01N 27/40

(57) ABSTRACT

A first tank 102a and a second tank 102b that can contain a solution containing an electrolyte; a thin membrane 103 that has a nanopore 104 and separates the first tank and the second tank as a partition; a first electrode 105 provided in the first tank; a second electrode 106 provided in the second tank; and a measurement system 109 that is connected to the first electrode and the second electrode and measures an ion current flowing through the nanopore, are provided. At least one electrode of the first electrode 105 and the second electrode 106 is made of a material containing a 1st group element, silver, and a 17th group element at least in an electrode surface part that is in contact with the solution.

### TECHNICAL FIELD

The present invention relates to an analysis device and an analysis method for a measurement object, particularly a biopolymer, using a pore provided in a thin membrane.

### BACKGROUND ART

When a solution containing an electrolyte is brought into contact with a pore having a diameter of approximately from 0.9 nm to several nanometers (referred to as a nanopore) provided in a thin membrane having a thickness of approximately from several angstroms to several tens of nanometers, and a difference in potential is caused in a direction across the thin membrane, it is possible to allow a measurement object which is charged to pass through the nanopore. In this case, when the measurement object passes through the nanopore, the electrical characteristics of the periphery of the nanopore, particularly the resistance, vary, and thus the measurement object can be detected by detecting the variation in the electrical characteristics. In the case where the measurement object is a biopolymer, electrical characteristics of the periphery of the nanopore vary in a pattern form according to the monomer sequence pattern of the biopolymer. A method for analyzing a monomer sequence of a biopolymer by utilizing this phenomenon is actively being studded in recent years. Among others, a technique based on a principle that the variation in ion current observed when a biopolymer passes through a nanopore differs depending on the monomer species is considered promising. In this technique, since the variation in ion current is determined using the current value when the biopolymer does not pass through the nanopores as a reference, it is desirable for increasing the measurement accuracy of the monomer sequence analysis that the ion current value takes stably a constant value. This technique does not require a chemical operation accompanies with fragmentation of the biopolymer unlike in conventional techniques and the biopolymer can be directly decoded. In the case where the biopolymer is a DNA, this technique is a next generation DNA basic sequence analysis system, and in the case where the biopolymer is a protein, it is an amino acid sequence analysis system, both of which are expected as a system by which a much larger sequence length than before can be decoded.

As a nanopore device, there are two types, that is, a biopore which uses a protein having a pore at the center and embedded in a lipid bilayer membrane and, and a solid pore in which an insulating thin membrane formed by a semiconductor processing process is processed so as to have a pore. In the biopore, a variation in ion current is measured using a pore (1.2 nm diameter and 0.6 nm thickness) in a modified protein (Mycobacterium smegmatis porin A (MspA), etc.) embedded in a lipid bilayer membrane as a biopolymer detecting unit. On the other hand, in the solid pore, a structure in which a nanopore is formed in a thin membrane of silicon nitride which is a semiconductor material or a thin membrane composed of a monomolecular layer such as graphene and molybdenum disulfide is used as a device.

In such an analysis device, a device composed of a nanopore device, a solution containing a measurement object and an electrolyte, and a pair of electrodes disposed across the nanopore device is used as a basic unit. Such a configuration is described in NPL 1. For the electrodes, a material that can give or receive electrons with respect to the electrolyte in the solution, in other words, a material that can undergo an electrochemical redox reaction is typically employed. Specifically, owing to the high chemical stability and reliability, an AgCl electrode is often used.

In the case where the measurement object is a DNA, a protein, or the like, application to the overall sequence analysis is particularly expected. However, since sufficient analysis performance cannot be achieved by a single nanopore, it is desired to enhance the analysis performance by arranging a plurality of nanopore devices in parallel in a practical use of the measurement device. The ion current measurement using a nanopore requires that two electrodes facing each other across the nanopores are connected by an electrolyte solution to enable measurement of the ion current. For further achieving the parallel arrangement in the ion current measurement, a mode is required in which an ion current generated in each nanopore can be individually measured by an independent electrode. In addition, the parallel-arranged electrodes have to be insulated from each other. Such a configuration is described in PTL 1.

### CITATION LIST

### Patent Literature

PTL 1: WO 2014/064443 A2

### Non-Patent Literature

NPL 1: Venta, K., et al., Differentiation of Short, Single-Stranded DNA Homopolymers in Solid-State Nanopores, ACS Nano 7(5), pp. 4629-4636 (2013)

### SUMMARY OF INVENTION

### Technical Problem

The performance of the analysis device described above depends on how large number of measurement objects can be analyzed within the service life of the analysis device. Accordingly, the continuous operation time of the analysis device is an important measure.

When analyzing a measurement object by causing an ion current to flow, since the electrode material in contact with a solution is gradually dissolved in the solution by a redox reaction, a phenomenon of degradation of electrodes with time occurs. This degradation phenomenon depends on the electrode area, and in the cases of causing a current with an identical current value to flow, the smaller the area, the shorter the service life of the electrode. In the cases of the analysis device with a parallel arrangement, in a constant analysis device area, increase in the degree of the parallel arrangement leads to decrease of each electrode area allocated to each nanopore device, and thus, the service life of the electrode accordingly decreases. Therefore, in the device with a parallel arrangement, a larger degree of the parallel arrangement leads to a shorter continuous operation time, and as a result, unfortunately resulting in decrease in analysis throughput. In addition, when focusing on a biopolymer as the measurement object, there arises a problem as follows: as the electrode is degraded, the ion current value varies with time and the measurement accuracy of the monomer sequence in the biopolymer accordingly decreases. Therefore, in conventional configurations, the increase in the degree of the parallel arrangement and the maintenances of analysis throughput and measurement accuracy are in trade-off relationships, and there is a problem that both the above properties cannot be simultaneously achieved.

### Solution to Problem

The analysis device according to the present invention includes a first tank and a second tank that can contain a solution containing an electrolyte, a thin membrane that has a nanopore and separates the first tank and the second tank as a partition, a first electrode provided in the first tank, a second electrode provided in the second tank, and a measurement system that is connected to the first electrode and the second electrode and measures an ion current flowing through the nanopore. Here, at least one electrode of the first electrode and the second electrode is made of a material containing a 1st group element, silver, and a 17th group element in at least an electrode surface part that is in contact with the solution.

In the electrolyte, a cation of the 1st group element contained in the electrode and an anion of the 17th group element contained in the electrode are preferably contained.

### Advantageous Effects of Invention

According to the present invention, service life of an electrode is enhanced and continuous operation time of an analysis device is increased. As a result, analysis throughput and measurement accuracy can be improved.

Other problems, configurations, and effects than the above will be apparent from the following description of the embodiments.

### BRIEF DESCRIPTION OF DRAWINGS

FIG. 1 is a cross sectional diagram showing an example of the analysis device according to the present invention.

FIG. 2 is cross sectional diagrams showing a structure of an electrode.

FIG. 3 is a flowchart showing an analysis procedure when a measurement object is analyzed.

FIG. 4 is a schematic diagram showing a variation in ion current caused during a biopolymer passes through a nanopore.

FIG. 5 shown an energy dispersive X-ray spectrum of an electrode.

FIG. 6 is a graph showing an experimental example of an ion current continuous measurement.

FIG. 7 is a cross sectional diagram showing another example of the analysis device according to the present invention.

FIG. 8 is a cross sectional diagram showing another example of the analysis device according to the present invention.

FIG. 9 is a cross sectional diagram showing another example of the analysis device according to the present invention.

FIG. 10 is a flowchart showing an analysis procedure when a measurement object is analyzed.

### DESCRIPTION OF EMBODIMENTS

Hereinunder, embodiments of the present invention will be described with reference to the drawings.

### Example 1

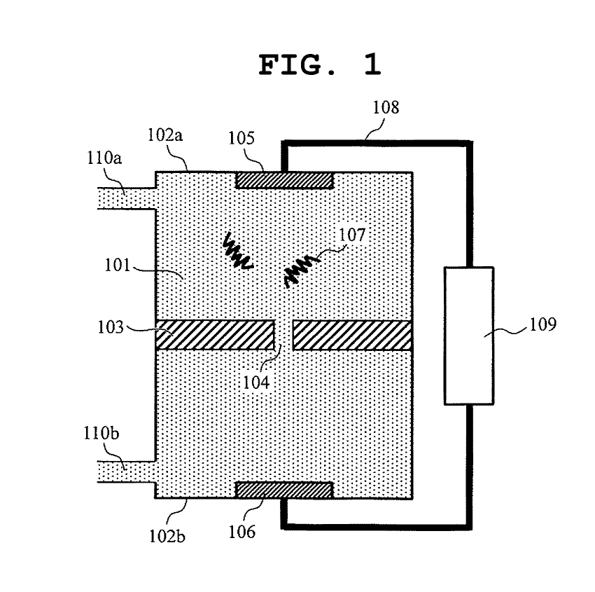

FIG. 1 is a cross sectional diagram showing an example of the analysis device according to the present invention.

The analysis device of the Example includes two tanks 102a and 102b that can contain a solution 101, a thin membrane 103 that has a nanopore 104 and separates the two tanks 102a and 102b as a partition, and two electrodes 105 and 106. The two electrodes 105 and 106 are respectively provided in the tanks 102a and 102b so as to face each other across the thin membrane 103 provided with the nanopore 104. The solution 101 contained in the two tanks contains an electrolyte, and a measurement object 107 may be contained in a solution in at least either one of the tanks. The ion current flowing through the nanopore 104 is measured by a measurement system 109 via a wire 108 bonded to the two electrodes 105 and 106.

The solution is filled in the two tanks 102a and 102b via inlets 110a and 110b. The measurement system 109 typically includes an ion current measuring unit, an analog/digital output converter, a data processing unit, a data display and output unit, and an input and output auxiliary unit in the ion current measuring unit, a current/voltage converter-type high speed amplification circuit is mounted, and in the data processing unit, a calculator, a temporary memory, and a nonvolatile memory are mounted. For reducing external noise, the analysis device is preferably covered with a Faraday cage.

The measurement object may be any object that can change in the electrical characteristics, particularly in the resistance, during passing through a nanopore, and typical examples include a biopolymer and a fine particle. As a biopolymer, a single strand DNA, a double strand DNA, an RNA, an oligonucleotide, and the like composed of nucleic acids as monomers, and a polypeptide and the like composed of amino acids as monomers are included. During the measurement, the object is preferably in a form of a linear polymer in which the higher order structure has been eliminated. As a fine particle, a microvesicle and a virus derived from a living organism, a resin-made nanoparticle, an inorganic nanoparticle, and the like are included. As a means for causing the measurement object to pass through the nanopore, delivery by electrophoresis is most preferred, but the means may be a solvent flow generated by, for example, a difference in pressure potential.

The nanopore 104 may have the minimum site that allows the measurement object 107 to pass through, and when a single strand DNA is mentioned as the biopolymer, the diameter may be approximately from 0.9 nm to 10 nm in which the single strand DNA can pass through, and the thickness of the thin membrane may be approximately from several angstroms to several tens of nanometers. When a fine particle is mentioned as the measurement object, a nanopore having a diameter that is 10% or more larger than the diameter of the fine particle and having a thickness of the thin membrane similar to the diameter of the fine particle is preferred. The nanopore may be a biopore or a solid pore. In the case of a biopore, the thin membrane is preferably a protein that has a pore at the center and that is embedded in an amphipathic molecular layer which can form a lipid bilayer membrane. In the case of a solid pore, the material of the thin membrane may be any material that can form a thin membrane by a semiconductor fine processing technique, and typical examples may include silicon nitride, silicon oxide, hafnium oxide, molybdenum disulfide, and graphene. In this case, examples of a method for forming a pore in the thin membrane include a method by electron beam irradiation by transmission electron microscope and the like and a method by dielectric breakdown by voltage application.

The material of the electrodes may be any material that contains a 1st group element (alkali metal), silver, and a 17th group element (halogen) (hereinafter, referred to as a halogenated alkali metal silver). As the 1st group element, at least one of lithium, sodium, potassium, rubidium, and cesium may be used. As the 17th group element, at least one of fluorine, chlorine, bromine, and iodine may be used.

For example, examples of a material composed of a single compound include compounds represented by the chemical formulae MAgX₂ and M₂AgX₃. In the formulae, M is a 1st group element, and X is a 17th group element. Specific examples include LiAgF₂, Li₂AgF₃, LiAgCl₂, Li₂AgCl₃, LiAgBr₂, Li₂AgBr₃, LiAgI₂, Li₂AgI₃, NaAgF₂, Na₂AgF₃, NaAgCl₂, Na₂AgCl₃, NaAgBr₂, Na₂AgBr₃, NaAgI₂, Na₂AgI₃, KAgF₂, K₂AgF₃, KAgCl₂, K₂AgCl₃, KAgBr₂, K₂AgBr₃, KAgI₂, K₂AgI₃, RbAgF₂, Rb₂AgF₃, RbAgCl₂, Rb₂AgCl₃, RbAgBr₂, Rb₂AgBr₃, RbAgI₂, Rb₂AgI₃, CsAgF₂, Cs₂AgF₃, CsAgCl₂, Cs₂AgCl₃, CsAgBr₂, Cs₂AgBr₃, CsAgI₂, and Cs₂AgI₃. A method for producing the compounds is described, for example, in a document “NAKAHARA Masayoshi, Muki kagoubutsu sakutai jiten(Inorganic compound and complex handbook), Kodansha Scientific, 1997” and the like. As an example, CsAgCl₂ is produced by adding a concentrated cesium chloride aqueous solution to a solution of AgCl in concentrated hydrochloric acid, heating, and then cooling the mixture. Cs₂AgCl₃ is produced by immersing AgCl in a concentrated cesium chloride aqueous solution which is heated.

A material used for the electrodes may be a mixture of plural compounds. Examples thereof include a mixture of AqX and MX. As with the above case, M is a 1st group element, and X is a 17th group element. Specific examples include AgCl-LiCl, AgCl-NaCl, AgCl-KCl, AgCl-RbCl, AgCl-CsCl, AgBr-LiBr, AgBr-NaBr, AgBr-KBr, AgBr-RbBr, AgBr-CsBr, AgI-LiI, AgI-NaI AgI-KI, AgI-RbI, and AgI-CsI. A method for producing such a mixture is described in a document “A. Chandra, et al., Journal of Electroceramics, 3(1), 47-52, 1999” and the like. In the above, mixtures in which the halogen contained in the halogenated silver and the halogen contained in the halogenated alkali are the same halogen are exemplified, but the halogen contained in the halogenated silver and the halogen contained in the halogenated alkali may be different halogens.

The solvent for the solution may be any solvent that can stably disperse the measurement object, that does not dissolve the electrode, and that does not impair giving and receiving electrons with respect to the electrode. Examples include water, alcohols (methanol, ethanol, isopropanol, etc.), acetic acid, acetone, acetonitrile, dimethyl formamide, and dimethyl sulfoxide. In the case of a biopolymer, water is most preferred.

The electrolyte contained in the solvent may be any electrolyte that can be dissolved in the solvent. A cation of the 1st group element contained in the electrode and an anion of the 17th group element contained in the electrode are preferably contained as electrolytes. Specific examples include a lithium ion, a sodium ion, a potassium ion, a rubidium ion, a cesium ion, a calcium ion, a magnesium ion, a fluoride ion, a chloride ion, a bromide ion, an iodide ion, a sulfate ion, a carbonate ion, a nitrate ion, an ammonium ion, a ferricyanide ion, and a ferrocyanide ion.

The signal intensity of the analysis device positively depends upon the electrical conductivity of the solvent dissolving the electrolyte. When water is used as the solvent, the electrical conductivities of alkali chloride aqueous solutions of 1 mol/kg at 25° C. are, for example, LiCl: 7.188 Sm⁻¹, NaCl: 8.405 Sm⁻¹, KCl: 10.84 Sm⁻¹, RbCl: 11.04 Sm⁻¹, and CsCl: 10.86 Sm⁻¹, and thus KCl, RbCl, CsCl, and the like, which have a high electrical conductivity, are preferred.

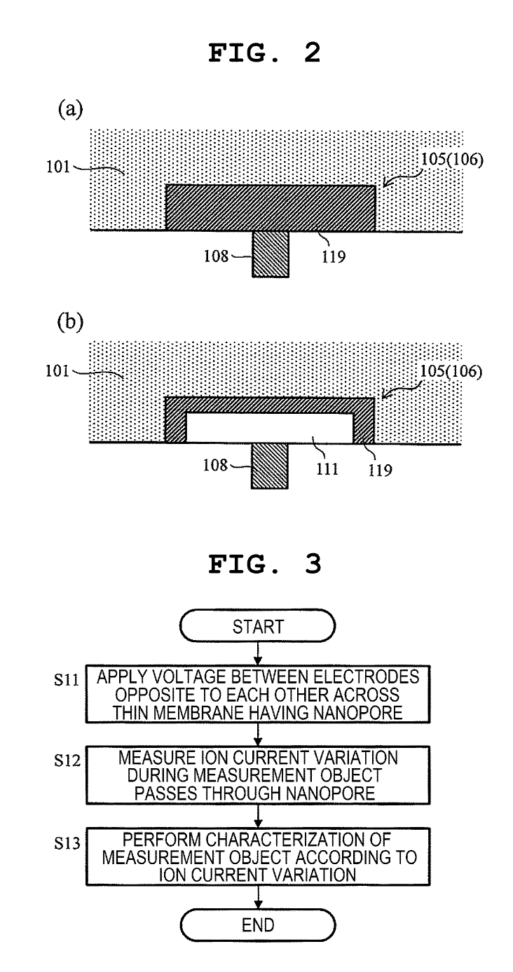

FIG. 2 is a cross sectional diagram showing an electrode structure. An electrode structure may be any structure as long as an electrode surface part that is in contact with a solution contains a halogenated alkali silver. Therefore, the entire electrode may be made of a material 119 of a halogenated alkali metal silver as shown in FIG. 2(a), or a surface of a material 111 capable of undergoing an electron giving/receiving reaction with respect to a halogenated alkali metal silver may be coated with the material 119 made of the halogenated alkali metal silver as shown in FIG. 2(b). The material 111 coated with a halogenated alkali metal silver is preferably silver in terms of bondability, and for example, a surface of a silver electrode connected to the wire 108 of copper may be coated with a halogenated alkali metal silver. The electrodes 105 and 106 are bonded to the wire 108, and electrical signals are sent to the measurement system 109. The electrodes may have any shape, but a shape giving a large area of the surface in contact with the solution is preferred. In this case, when the resistance of the electrode is so high that it cannot be neglected with respect to the resistance of the nanopore, the variation in ion current during the measurement object passes through the nanopore decreases, deteriorating the signal/noise ratio. For this reason, the thickness of the halogenated alkali silver coating is preferably determined so that the resistance is sufficiently smaller than the resistance of the nanopore. Specifically, the thickness of the halogenated alkali silver coating is desirably determined so that the resistance of the electrode is 1/100 of the resistance of the nanopore or lower.

A voltage is applied on at least either one of the electrodes 105 and 106 to cause a difference in potential, whereby an ion current is induced to detect the measurement object. Thus, either one of the two electrodes 105 and 106 serves as an anode (an electrode from which electrons flow into the solution side), and the other one serves as a cathode (an electrode which receives electrons from the solution side). During this time, by an electrochemical reaction, a reaction in which the electrode material is dissolved into the solution side is caused. Although the electrode material is dissolved typically on the anode side in many cases, the dissolution of the electrode material may occur on the cathode side depending on the applied voltage and the combination of the electrode and the electrolyte.

The electrodes of the Example are made of a material having a larger number of elements that can be ionized into the solution by giving or receiving electrons, and therefore the total amount of the electric charge that can be released per unit area is increased as compared with a conventional AgCl electrode, resulting in increase of the electrode service life. The increase of the electrode service life leads to enhancement of the continuous operation time of the analysis device, thereby increasing the analysis throughput. In addition, the ion current value becomes less liable to vary with time, increasing the measurement accuracy for the measurement object.

The electrode containing a halogenated alkali metal silver may be used as either one of the two electrodes 105 and 106, but it is preferred that an electrode containing a halogenated alkali metal silver is used also as the other electrode, and the anode and the cathode are desirably made of the same material. When electrodes made of different materials are connected, the electrodes differ in the standard potential in the electrode reaction on the surface thereof, and thus an electromotive force inevitably occurs between the two electrodes. Accordingly, an offset voltage is undesirably applied in the state where an external voltage is not applied between the electrodes, resulting in variation of the ion current value. As a result, there arises a problem that the measurement accuracy of the measurement object decreases. For avoiding the problem, both the electrodes preferably contain the same halogenated alkali metal silver.

In the analysis device of the Example, a measurement object is sometimes trapped in the nanopore for any cause. In this case, the state of trapping can be eliminated by reversing the voltage applied between the two electrodes to apply a reverse force to the measurement object. However, there arises a problem that when the applied voltage is reversed, the electrode degraded is also changed. Also from this standpoint, the two electrodes preferably contain the same halogenated alkali metal silver.

In addition, as the electrolyte contained in the solvent, it is preferred to use a cation of the 1st group element and an anion of the 17th group element that are contained in the electrode containing a halogenated alkali metal silver. According to the same discussion as above, when an electrolyte of a different element from that contained in the electrode is used, an electromotive force occurs due to the resulting difference in the standard potential of the electrode reaction, thereby causing deterioration of the measurement accuracy. Accordingly, when a cation of the 1st group element and an anion of the 17th group element that are contained in the electrode containing a halogenated alkali metal silver are used as the electrolyte, an electromotive force does not occur and a highly accurate current measurement can be performed.

FIG. 3 is a flowchart showing an analysis procedure in analysis of a measurement object using the analysis device of the Example.

Upon performing the analysis, a solution containing an electrolyte is put in one tank 102b of an analysis device having the structure shown in FIG. 1, a solution containing the electrolyte and a measurement object is put in the other tank 102a. Incidentally, a solution containing the electrolyte and the measurement object may be put in both the tanks 102a and 102b. Then, a voltage is applied between the electrodes 105 and 106 which are opposite to each other across the thin membrane 103 having the nanopore 104 (S11). Then, a phenomenon that the measurement object which is charged approaches the nanopore 104 by electrophoresis and passes through the nanopore 104 is induced. At this time, the ion current value flowing through the nanopore 104 is reduced due to the presence of the measurement object. The variation in the ion current is measured by the measurement system 109 (S12). Then, according to the ion current variation, the characterization of the measurement object is performed (S13).

FIG. 4 is a schematic diagram showing a variation in ion current caused during a biopolymer passes through a nanopore. For example, in the case where the measurement object is a biopolymer such as a DNA, as shown FIG. 4, the ion current value varies in a pattern form depending on the monomer sequence pattern of the biopolymer. For this reason, it is possible to perform the monomer sequence analysis using the variation pattern in the ion current value. Such a method is disclosed, for example, in a document “A. H. Laszlo, et al., Nat. Biotechnol., 32, 829-833, 2014”. When the measurement object is a sphere particle, since the on current variation is known to vary depending on the volume and the shape of the sphere particle, it is possible to analyze the particle size distribution and the shape characteristics of the sphere particle. Such a method is disclosed, for example, in a document “P. Terejanazky, et al., Anal. Chem., 86, 4688-4697, 2014”. In this case, by using the electrode configuration in the Example, it is possible to enhance the electrode service life to increase the continuous operation time of the analysis device, thereby improving the analysis throughput and the measurement accuracy.

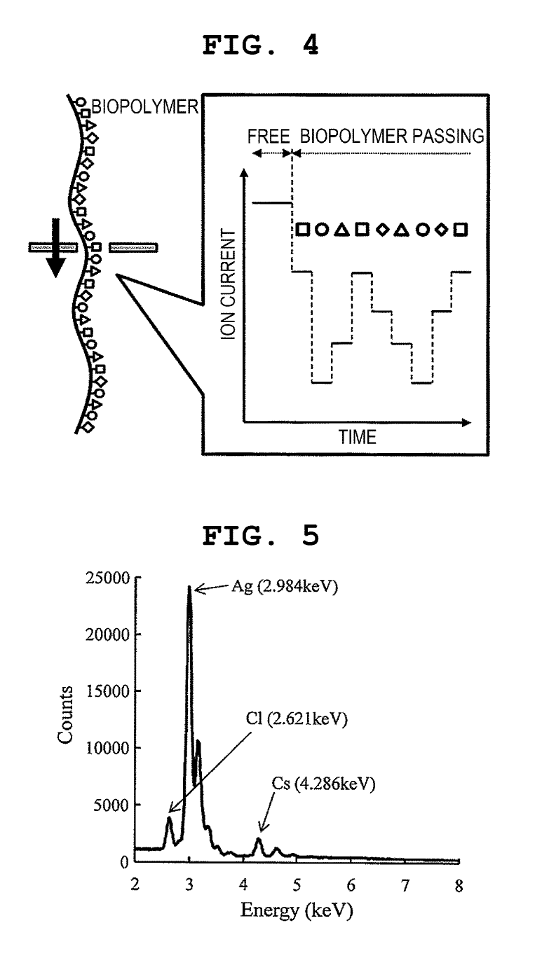

FIG. 5 is an energy dispersive X-ray spectrum showing an analysis result of the electrode produced in the Example. A surface part of an electrode which was produced by coating silver with a halogenated alkali silver while selecting cesium as the 1st group element and chlorine as the 17th group element was subjected to an energy dispersive X-ray spectrometry. As a result, a spectrum having peaks corresponding to cesium (4.286 keV), silver (2.984 keV), and chlorine (2.621 keV) was obtained. Accordingly, an electrode surely containing cesium, silver, and chlorine could be produced.

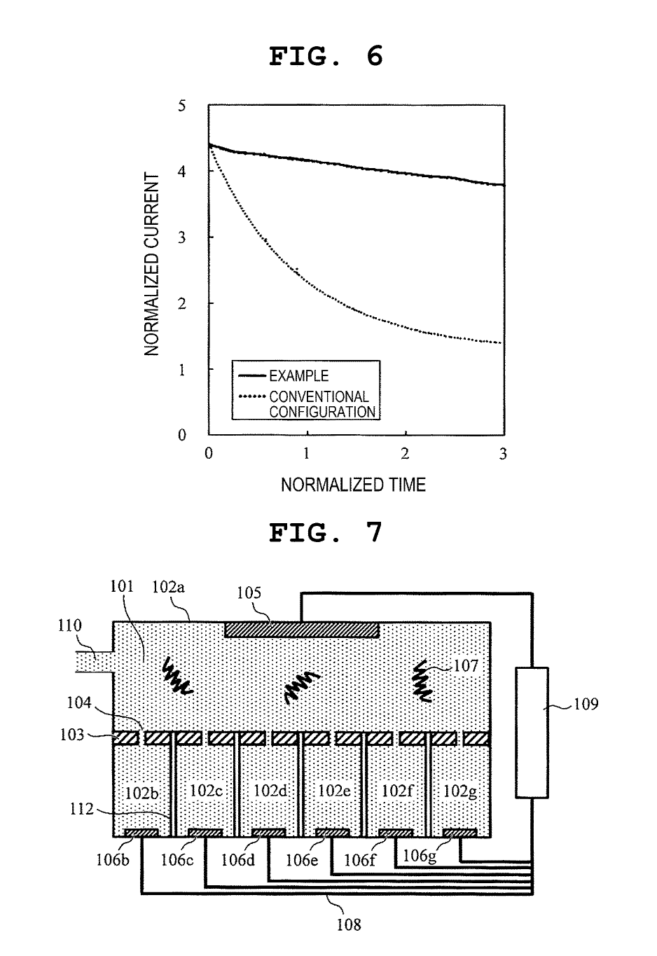

FIG. 6 is a graph showing an experiment example of an ion current continuous measurement by the analysis device of the Example. In the analysis device of the Example shown in FIG. 1, the diameter of the nanopore was 2 nm, the thickness of the thin membrane was 5 nm, and two electrodes made of the same material were used as the electrodes 105 and 106. As the electrode material, an electrode containing cesium, silver, and chlorine with which the observation was performed in FIG. 5 was employed, and for comparison, a similar experiment was performed while a conventional AgCl electrode was incorporated in an analysis device. As the solution, a cesium chloride aqueous solution of a concentration of 1 M was used. In FIG. 6, measurement results of the time dependence of the current value in the case where the measurements were started at the same current value are shown. It was found that in the configuration of the Example, the current drop after an identical time was reduced as compared with the conventional structure. Accordingly, it was confirmed that the continuous operation time of the analysis device is increased, and the analysis throughput and measurement accuracy are enhanced by the configuration of the Example.

### Example 2

FIG. 7 is a cross sectional diagram showing another example of the analysis device according to the present invention. Although an analysis device having a single nanopore was described in Example 1, in this Example, an analysis device having nanopores arranged in parallel is described.

In the analysis device in the Example shown in FIG. 7, a plurality of tanks 102a, 102b, . . . , and 102g that can contain the solution 101 are provided, a plurality of the thin membranes 103 each having the nanopore 104 are arranged in parallel, and minute electrodes 106b, 106c, . . . , and 106g of a number corresponding to the number of the nanopores are arranged in parallel in one-to-one correspondence. A common electrode 105 is disposed on the opposite side of the plurality of minute electrodes 106b, 106c, . . . , and 106g at a position facing the nanopores. That is, the plurality of the second tanks 102b, . . . , and 102g are disposed in parallel so as to be adjacent to the first tank 102a, and the plurality of second tanks 102b, . . . , and 102g are each separated from the first tank 102a by the thin membrane 103 having the nanopore 104, the electrodes 106b, 106c, . . . , and 106g are individually provided in the second tanks 102b, . . . , and 102g, respectively. Each of the minute electrodes is connected to the measurement system 109 via an independent wire, and each ion current is independently measured. For the purpose of enhancing the measurement accuracy, the nanopores are insulated from each other by partition walls 112 for suppressing a current crosstalk between the nanopores. The solution 101 containing the measurement object 107 is typically filled in the tank 102a on the common electrode 105 side via an inlet 110.

The materials and the structures of the common electrode 105 and the minute electrodes 106b, 106c, . . . , and 106g are the same as in Example 1.

In the Example, the same effects as in Example 1 can be achieved. Since the area of the minute electrode is reduced and the electrode service life is shortened according to the number of the parallel nanopores, the effect of enhancing the electrode service life is especially effective in the analysis device of the Example in which the nanopores are arranged in parallel.

### Example 3

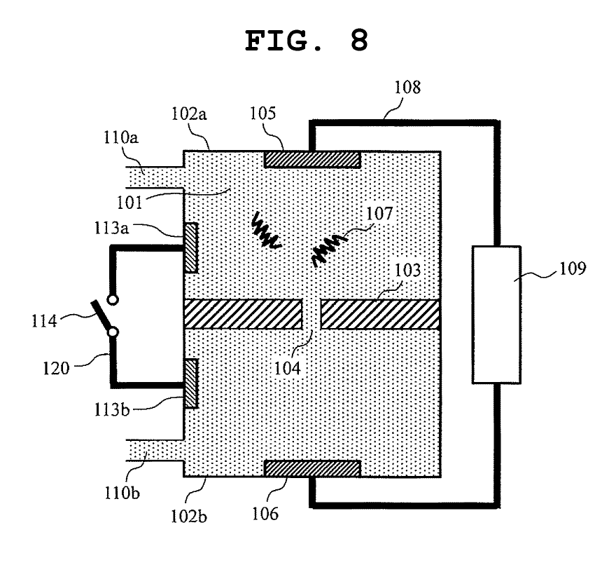

FIG. 8 is a cross sectional diagram showing another example of the analysis device according to the present invention.

A thin membrane for biopolymer measurement is susceptible to a potential difference between the solutions of the opposite sides of the thin membrane, and is possibly broken by the potential difference. In particular, when the electrostatic capacity of the analysis device is tried to be lowered for reducing the noise current, the thin membrane is liable to be broken. This thin membrane breakdown phenomenon is caused in the following manner: when solutions are individually put in the solution tanks on the opposite sides of the thin membrane, an initial charge difference ΔQ is inevitably caused between the solutions, and therefore a potential difference ΔV (=ΔQ/C) applied on the thin membrane is amplified with reduction in the electrostatic capacity C of the thin membrane having a nanopore, leading to dielectric breakdown of the thin membrane. Thus, for avoiding the breakdown phenomenon, one pair of electrodes other than the electrodes for ion current measurement are newly placed on the opposite sides of the thin membrane, whereby it becomes possible to reduce the charge difference to prevent the thin membrane breakdown.

FIG. 8 illustrates a configuration diagram based on the configuration shown in FIG. 1 in which electrodes 113a and 113b for charge difference reduction additionally disposed in the tanks 102a and 102b, respectively. The electrodes 105 and 106 for ion current measurement contain a halogenated alkali silver in at least an electrode surface part that is in contact with the solution as with the case of Example 1. The electrodes 113a and 113b for charge difference reduction are electrically connected via an external circuit, that is, a wire 120 through an opening/closing switch 114. The switch 114 provided on the wire 120 is closed when the charge difference is to be reduced and electrically connects the two tanks 102a and 102b via the electrodes 113a and 113b. When the step of the charge difference reduction is completed and the measurement object is to be analyzed using the thin membrane 103 having the nanopore 104, the switch 114 is required to be opened so that the two tanks 102a and 102b are electrically connected to the electrodes 105 and 106 only via the nanopore 104.

The electrodes 105 and 106 for ion current measurement are required to be electrodes containing a halogenated alkali silver. However, since the charge amount flowing through the two electrodes 113a and 113b due to the charge difference during the switch 114 is closed is small, the electrodes 113a and 113b are not always required to be electrodes containing a halogenated alkali silver. The electrode material for the electrodes 113a and 113b may be any material that can give and receive electrons with respect to the solution containing an electrolyte. Typically, the material of the electrode maybe AgCl, Pt, and Au.

Also in the Example, the same effects as in Example 1 can be achieved.

### Example 4

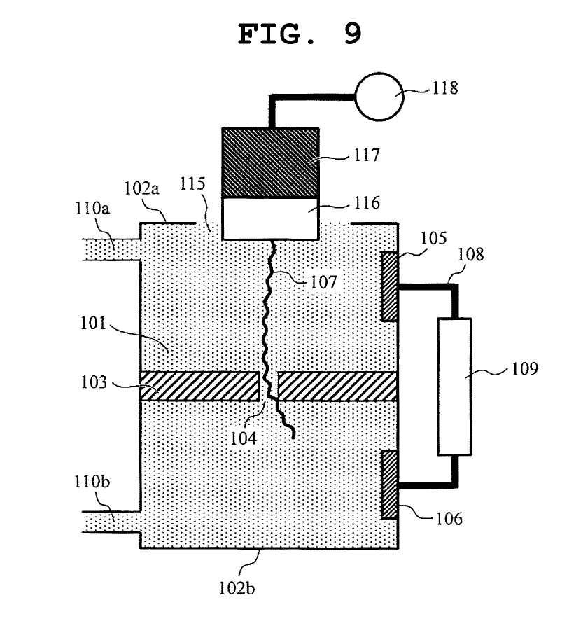

FIG. 9 is a cross sectional diagram showing another example of the analysis device according to the present invention. FIG. 9 illustrates a configuration based on the configuration of FIG. 1 in which a movable substrate 116 inserted into an opening 115 of the tank 102a, a driving mechanism 117 for driving the substrate 116, and a control system 118 for the driving mechanism 117 are added. The electrodes 105 and 106 for ion current measurement are electrodes containing a halogenated alkali silver at least in an electrode surface part that is in contact with the solution as with the case of Example 1.

The measurement object 107 is immobilized on the substrate 116 at one end, and the relative position of the measurement object 107 with respect to the nanopore 104 can be arbitrarily and precisely controlled by the driving mechanism 117 via the control system 113. As the driving mechanism 117, a piezoelectric element or a motor can be used. Alternatively, the measurement object 107 may be driven by being immobilized to a cantilever in the same way as in an atomic force microscope. The configuration as described above is described, for example, in a document “E. N. Nelson, et al., ACS Nano, 8(6), 5484, 2014”. In the case where the measurement object is a biopolymer, in order to perform a monomer sequence analysis, it is preferred that the biopolymer passing through the nanopore 104 is precisely moved on a monomer basis. The configuration of the Example enables the precise control of the measurement object, thereby enhancing the measurement accuracy.

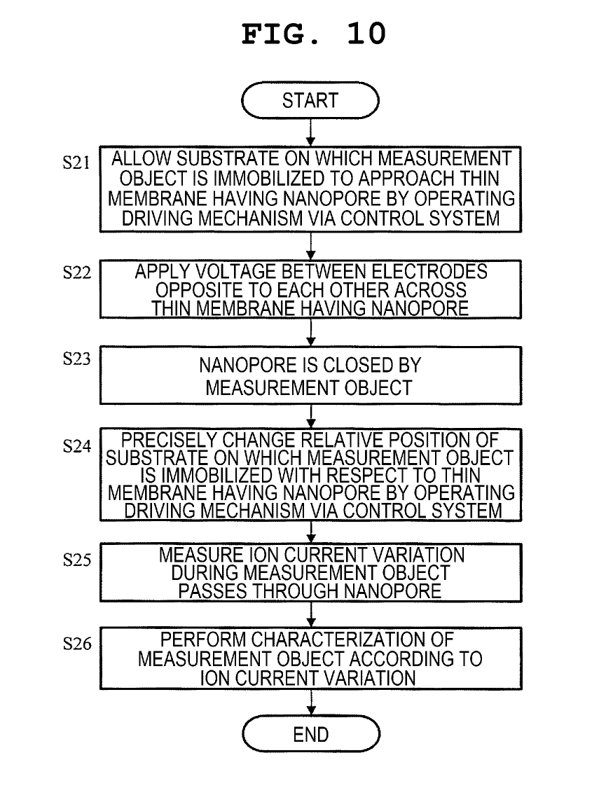

FIG. 10 is a flow chart showing an analysis procedure in analysis of a measurement object using the configuration of the Example. First, the substrate 116 on which the measurement object 107 is immobilized is caused to approach the thin membrane 103 having the nanopore 104 by operating the driving mechanism 117 via the control system 118 (S21). Next, a voltage is applied between the electrodes 105 and 106 which are opposite to each other across the thin membrane 103 having the nanopore 104 (S22). Then, the measurement object 107 charged approaches the nanopore 104 by electrophoresis, and the nanopore 104 is closed by the measurement object 107 (S23). In this time, by operating the driving mechanism 117 via the control system 118, the relative position of the substrate 116 on which the measurement object 107 is immobilized with respect to the thin membrane 103 having the nanopore 104 is precisely changed (S24). Then, in the case where the measurement object 107 is a biopolymer, the position of the biopolymer with respect to the nanopore 104 is precisely shifted on a monomer basis. Therefore, by measuring the ion current variation at that time, it is possible to enhance the measurement accuracy (S25). Finally, the characterization of the measurement object is performed according to the ion current variation measured with the enhanced measurement accuracy (S26).

Also in the Example, as with the case of Example 1, it is possible to enhance the electrode service life, thereby improving the throughput and the measurement accuracy of the analysis device.

Incidentally, the present invention is not to be limited to the Examples described above, and various modified examples are included. For example, the Examples described above are detailed explanations for understanding the present invention better, and the present invention are not always to be limited to an example including all the configurations in the description. In addition, a part of the configuration of one example may be replaced by a configuration in another example, or a configuration in one example may be added to a configuration of another example. In a part of a configuration of each example, another configuration may be added, deleted, or substituted.

### REFERENCE SIGN LIST

101: Solution containing electrolyte

102a, 102b: Tank

103: Thin membrane

104: Nanopore

105, 106: Electrode for ion current measurement

107: Measurement object

108: Wire

109: Measurement system

112: Partition wall

113a, 113b: Electrode for charge difference reduction

114: Switch

115: Opening

116: Substrate

117: Driving mechanism

118: Control system

1. An analysis device, comprising:
a first tank and a second tank that can contain a solution containing an electrolyte;
a thin membrane that has a nanopore and separates the first tank and the second tank as a partition;
a first electrode provided in the first tank;
a second electrode provided in the second tank; and
a measurement system that is connected to the first electrode and the second electrode and measures an ion current flowing through the nanopore,
wherein at least one electrode of the first electrode and the second electrode is made of a material containing a 1st group element, silver, and a 17th group element at least in an electrode surface part that is in contact with the solution.

2. The analysis device according to claim 1, wherein the 1st group element is at least one of lithium, sodium, potassium, rubidium, and cesium.

3. The analysis device according to claim 1, wherein the 17th group element is at least one or fluorine, chlorine, bromine, and iodine.

4. The analysis device according to claim 1, wherein the solution contains a cation of the 1st group element contained in the electrode.

5. The analysis device according to claim 1, wherein the solution contains an anion of the 17th group element contained in the electrode.

6. The analysis device according to claim 1, wherein the at least electrode surface part that is in contact with the solution, of the at least one electrode is made of a material represented by the chemical formula MAgX₂ or M₂AgX₃ (wherein M is a 1st group element and X is a 17th group element).

7. The analysis device according to claim 1, wherein the at least electrode surface part that is in contact with the solution, of the at least one electrode is made of a mixture of a material represented. by the chemical formula AgX and a material represented by the chemical formula MX (wherein M is a 1st group element, and X is a 17th group element).

8. The analysis device according to claim 1, further comprising:
a third electrode provided in the first tank;
a fourth electrode provided in the second tank; and
an external circuit in which the third electrode and the fourth electrode are electrically connected via a switch.

9. The analysis device according to claim 1, further comprising:
a substrate that is inserted in the first tank and on which a measurement object is immobilized;
a driving mechanism that drives the substrate with respect to the thin membrane; and
a control system that controls the driving mechanism.

10. The analysis device according to claim 1, wherein
a plurality of the second tanks are arranged in parallel so as to be adjacent to the first tank,
the plurality of the second tanks are each separated from the first tank by the thin membrane having a nanopore,
the second electrodes are individually provided in the second tanks, respectively, and
the individual second electrodes is each connected to the measurement system.

11. An analysis method, comprising:
putting a solution containing an electrolyte into one of two tanks which are separated by a thin membrane having a nanopore and in which a first electrode and a second electrode are respectively provided, and putting a solution containing the electrolyte and a measurement object into the other tank;
detecting variation in ion current flowing between the first electrode and the second electrode through the nanopore; and
measuring the measurement object based on the detected variation in the ion current,
wherein at least one of the first electrode and the second electrode is made of a material containing a 1st group element, silver, and a 17th group element at least in an electrode surface part that is in contact with the solution.

12. The analysis method according to claim 11, wherein the measurement object is immobilized on a substrate, and wherein the method further comprises driving the substrate with respect to the thin membrane.
